(19) United States
(12) Patent Application Publication
(10) Pub. No.: US 2002/0167493 A1
(43) Pub. Date: Nov. 14, 2002

(54) Pointing device having a roller with a rough surface

(76) Inventor: Hao-Fong Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,554

(22) Filed: Sep. 19, 2001

(30) Foreign Application Priority Data
May 11, 2001 (TW) 090111348

(51) Int. Cl. G09G 5/08

(52) U.S. Cl. 345/167

(57) ABSTRACT

A pointing device has a roller with a plurality of irregular protrusions, a light source for emitting light, a light sensor for detecting light reflected from the roller, and control circuitry for controlling operations of the pointing device. When the roller rotates, reflected light received by the light sensor changes according to the protrusions on the surface of the roller, and the control circuitry generates corresponding pointing signals according to the reflected light received by the light sensor.

### BACKGROUND OF INVENTION

1. Field of the Invention

The present invention relates to a pointing device, and more particularly, to a pointing device having a roller with a rough surface.

2. Description of the Prior Art

Today, graphic user interfaces (GUIs) are the primary interface for operating systems. The graphical nature of the user interface offers a more intuitive presentation to the user, and is, visually, more pleasing. With respect to the Internet and computer games, graphical user interfaces has become the standard. One necessary piece of equipment for use of a GUI is a pointing device. Generally, this is either a mouse or a track ball.

Please refer to FIG. 1. FIG. 1 is a diagram of a prior art pointing device 10. The pointing device 10 is a track ball 10. The track ball 10 has a roller 12. A surface of the roller 12 is formed by printing apparently randomly sized and positioned spots 14. Control circuitry in the track ball 10 has a sensor system that notes the patterns and relative positions of the differently sized spots 14 on the roller 12. As a user rotates the roller 12 of the track ball 10, a light source in the track ball 10 illuminates the roller 12, and a light sensor detects light reflecting from the roller 12. The control circuitry compares a previous image of the roller 12 will a current image of the roller 12 to compare the positional change of the pattern to determine the direction and distance of movement of the roller 12.

In the manufacturing process of the roller 12, a printing process must be included so that the arrangement of spots 14 are provided on the roller 12. This printing process, however, is relatively complex, and thus relatively expensive.

### SUMMARY OF INVENTION

It is therefore a primary objective of the present invention to provide a pointing device having a roller with a rough surface to simplify the manufacturing process of the roller.

According to claimed invention, a pointing device has a roller with a plurality of irregular protrusions, a light source for emitting light, a light sensor for detecting light reflected from the roller, and control circuitry for controlling operations of the pointing device. When the roller rotates, the reflected light received by the light sensor will change according to the protrusions on the surface of the roller, and the control circuitry will generate corresponding pointing signals according to the reflected light received by the light sensor.

It is an advantage of the present invention that the roller of the pointing device does not require a printing process to form the irregular protrusions, and so the overall cost of the pointing device is reduced.

These and other objectives and advantages of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a diagram of a prior art pointing device.

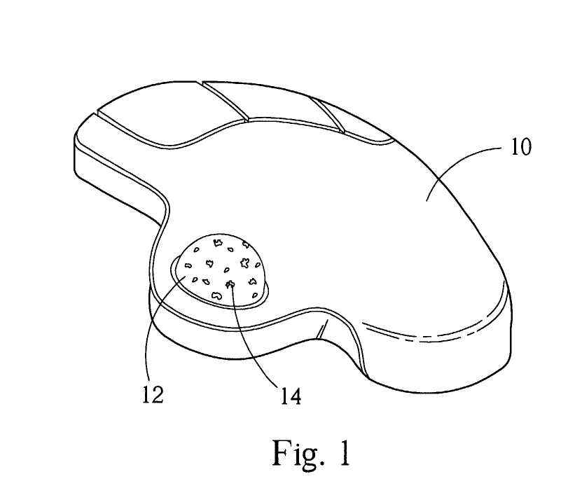

FIG. 2 is a diagram of a present invention pointing device.

FIG. 3 is a block diagram of the pointing device shown in FIG. 2.

### DETAILED DESCRIPTION

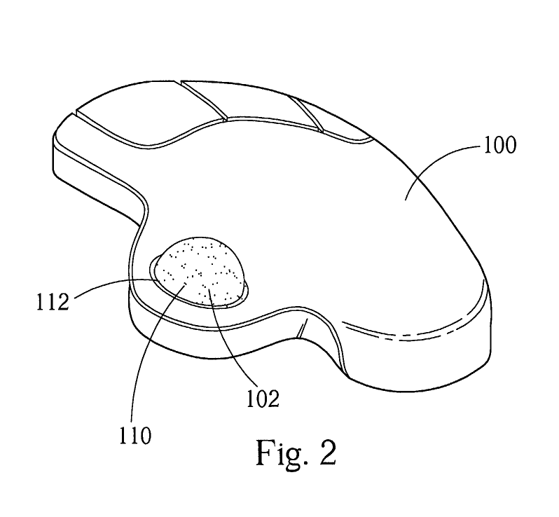

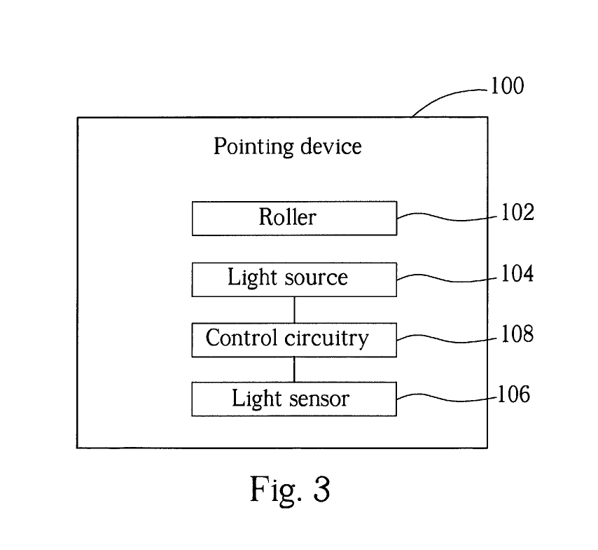

Please refer to FIG. 2 and FIG. 3. FIG. 2 is a diagram of a present invention pointing device 100. FIG. 3 is a block diagram of the pointing device 100. The preferred embodiment of the present invention pointing device 100 is a track ball 100. The track ball 100 comprises a roller 102, a light source 104, a light sensor 106, and a control circuitry 108. The roller 102 has a surface with a plurality of fine, irregular protrusions 110. The top surface of the roller 102 is coated with a transparent layer 112 to protect the irregular protrusions 110. The light source 104 is used to emit light. The light sensor 106 is used to detect light reflected from the roller 102 and to send a corresponding image to a digital signal processor of the control circuitry 108 to obtain displacement signals. The light sensor 106 includes a lens for focusing light reflected from the surface of the roller 102. When the roller 102 rotates, the image signals generated by the light sensor 106 change according to the protrusions 110 on the surface of the roller 102. The control circuitry 108 generates corresponding pointing signals according to the image signals generated by the light sensor 106.

The control circuitry in the track ball 100 has a memory. The memory continuously records images of the patterns and relative positions of the irregular protrusions on the roller 102 in the form of a current image and a previous image.

When a user rotates the roller 102 of the track ball 100, the roller 102 with irregular protrusions 110 reflects light from the light source 104. According to the irregular protrusions 110, the angles or intensity of the reflected light will vary. After the light sensor 106 receives this modulated reflected light to generate a current image, the control circuitry 108 compares the change of the patterns of the protrusions 110 in this current image with those of a previous image to determine the direction and distance of the movement of the roller 102.

Because the roller 102 has the irregular protrusions 110, to prevent inconvenience to the user due to the rough surface of the roller 102, and to enable smooth operations of the roller 102, the present invention provides a smooth transparent layer 112 over the irregular protrusions 110 of the roller 102. In this manner, the roller 102 provides a smooth, comfortable surface to the user, while still enabling the light sensor 106 to detect the fine, irregular protrusions 110.

Besides track balls, the other most common pointing device is the mouse. The present invention may also be applied to mice. As with the present invention track ball 100, the surface of a roller under the mouse will have irregular protrusions formed by performing a sandblasting process. Also, a transparent layer over the rough surface of the roller avoids excessive friction when the mouse is dragged over a surface.

Sandblasting is used to form the fine, irregular protrusions 110 on the roller 102.

Other may also be used to form the irregular protrusions 110 of the present invention.

For example, the roller 102 can be directly formed with a mold that has an interior surface with a plurality of irregular indentations. Or, the roller 102 can be formed by performing an oscillating grinding process.

In contrast to the prior art pointing device 10, the present invention pointing device 100 uses protrusions 110 on the surface of the roller 102 to replace the original printed surface of varying sized spots 14. The roller 102 thus provides a rough surface to reflect light from the light source 104. The irregularity of the protrusions 110 ensures that the angles and intensity of reflected light is sufficiently various for proper detection. After the light sensor 106 receives reflected light, the control circuitry 108 in the pointing device 100 compares previous and current images to determine the direction of movement the pointing device 100 and generate corresponding pointing signals. The present invention provides a more convenient and economical method to improve the resolution of the optical pointing device 100.

Those skilled in the art will readily observe that numerous modification and alterations of the device may be made while retaining the teachings of the invention.

Accordingly, the above disclosure should be construed as limited only by the metes and bounds of the appended claims.

What is claimed is:

1. A pointing device comprising:
a roller having a surface with a plurality of irregular protrusions;
a light source for emitting light;
a light sensor for detecting light reflected from the roller; and
control circuitry for controlling operations of the pointing device;
wherein when the roller rotates, the reflected light received by the light sensor will change according to the protrusions on the surface of the roller, and the control circuitry will generate corresponding pointing signals according to the reflected light received by the light sensor.

2. The pointing device of claim 1 wherein the light sensor comprises a lens for collecting light reflected from the roller.

3. The pointing device of claim 1 wherein the protrusions on the surface of the roller are formed by performing a sandblasting process.

4. The pointing device of claim 1 wherein the roller is formed by using a mold having an interior surface with a plurality of irregular indentations.

5. The pointing device of claim 1 wherein the protrusions on the surface of the roller are generated by performing an oscillated grinding process.

6. The pointing device of claim 1 wherein the surface of the roller is coated with a transparent layer.

7. The pointing device of claim 1 being a track ball.

8. The pointing device of claim 1 being a mouse.

9. A method for making a roller used in an optical pointing device, the optical pointing device comprising a roller, a light source for emitting light, a light sensor for detecting light reflected from the roller, and control circuitry for generating displacement signals according to light received by the light sensor, the method comprising:
forming irregular protrusions on a surface of the roller to increase resolution of the optical pointing device.

10. The method of claim 9 wherein the protrusions on the surface of the roller are formed by performing a sandblasting process.

11. The method of claim 9 wherein the protrusions on the surface of the roller are generated by performing an oscillated grinding process.

12. The method of claim 9 wherein the roller is formed by using a mold having an interior surface with a plurality of irregular indentations.

13. The method of claim 9 wherein the surface of the roller is coated with a transparent layer.
